(19) United States
(12) Patent Application Publication
(10) Pub. No.: US 2009/0054268 A1
(43) Pub. Date: Feb. 26, 2009

(54) Use of substituted polyethyleneimines as gas hydrate inhibitors with improved biodegradability

(75) Inventors: Dirk Leinweber, Kelkheim (DE); Alexander Roesch, Gimbsheim (DE); Michael Feustel, Kongernheim (DE)

Correspondence Address: CLARIANT CORPORATION;INTELLECTUAL PROPERTY DEPARTMENT, 4000 MONROE ROAD, CHARLOTTE, NC, 28205, US

(73) Assignee: Clariant International Ltd.

(21) Appl. No.: 12/221,300

(22) Filed: Aug. 1, 2008

(30) Foreign Application Priority Data
Aug. 6, 2007 (DE) 10 2007037015.8

(51) Int. Cl. C09K 8/52; C08G 69/14

(52) U.S. Cl. 507/90; 528/323

(57) ABSTRACT

The invention provides for the use of substituted polyethyleneimines containing structural units of the formula (1),

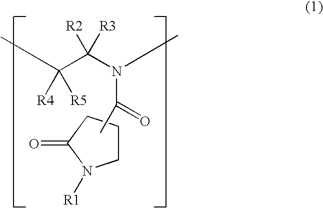

where
R1 is H, C₁-C₃₀-alkyl, C₁-C₃₀-alkenyl or C₇-C₃₀-alkylaryl
R2, R3, R4, R5 are each independently H or C₁-C₆-alkyl,
in amounts of from 0.01 to 2% by weight to prevent the formation of gas hydrates in aqueous phases which are in contact with a gaseous, liquid or solid organic phase.

The present invention is described in the German priority application No. 102007037015.8, filed Jun. 08, 2007, which is hereby incorporated by reference as is fully disclosed herein.

The present invention relates to the use of substituted polyethyleneimines as gas hydrate inhibitors and to a process for inhibiting nucleation, growth and/or agglomeration of gas hydrates by adding an effective amount of an inhibitor which comprises substituted polyethyleneimines to a polyphasic mixture which consists of water, gas and optionally condensate and has a tendency to form gas hydrates, or to a drilling fluid having a tendency to form gas hydrates.

Gas hydrates are crystalline inclusion compounds of gas molecules in water which form under certain temperature and pressure conditions (low temperature and high pressure). The water molecules form cage structures around the appropriate gas molecules. The lattice structure formed from the water molecules is thermodynamically unstable and is only stabilized by the incorporation of guest molecules. Depending on pressure and gas composition, these icelike compounds can exist even beyond the freezing point of water (up to above 25° C.).

In the mineral oil and natural gas industry, great significance attaches in particular to the gas hydrates which form from water and the natural gas constituents methane, ethane, propane, isobutane, n-butane, nitrogen, carbon dioxide and hydrogen sulfide. Especially in modern natural gas extraction, the existence of these gas hydrates constitutes a great problem, especially when wet gas or polyphasic mixtures of water, gas and alkane mixtures are subjected to low temperatures under high pressure. As a consequence of their insolubility and crystalline structure, the formation of gas hydrates leads here to the blockage of a wide variety of extraction equipment such as pipelines, valves or production equipment in which wet gas or polyphasic mixtures are transported over relatively long distances at relatively low temperatures, as occurs especially in colder regions of the earth or on the seabed. Moreover, gas hydrate formation can also lead to problems in the course of the drilling operation to develop new gas or crude oil deposits at the appropriate pressure and temperature conditions by the formation of gas hydrates in the drilling fluids.

In order to prevent such problems, gas hydrate formation in gas pipelines, in the course of transport of polyphasic mixtures or in drilling fluids, can be suppressed by using relatively large amounts (more than 10% by weight, based on the weight of the aqueous phase) of lower alcohols such as methanol, glycol or diethylene glycol. The addition of these additives has the effect that the thermodynamic limit of gas hydrate formation is shifted to lower temperatures and higher pressures (thermodynamic inhibition). However, the addition of these thermodynamic inhibitors causes serious safety problems (flashpoint and toxicity of the alcohols), logistical problems (large storage tanks, recycling of these solvents) and accordingly high costs, especially in offshore extraction.

Attempts are therefore now being made to replace thermodynamic inhibitors by adding additives in amounts of <2% in temperature and pressure ranges in which gas hydrates can form. These additives either delay gas hydrate formation (kinetic inhibitors) or keep the gas hydrate agglomerates small and therefore pumpable, so that they can be transported through the pipeline (agglomerate inhibitors or anti-agglomerants). The inhibitors used either prevent nucleation and/or the growth of the gas hydrate particles, or modify the hydrate growth in such a way that relatively small hydrate particles result.

The gas hydrate inhibitors which have been described in the patent literature, in addition to the known thermodynamic inhibitors, are a multitude of monomeric and also polymeric substance classes which are kinetic inhibitors or antiagglomerants. Of particular significance in this context are polymers having a carbon backbone which contain both cyclic (pyrrolidone or caprolactam radicals) and acyclic amide structures in the side groups.

For instance, WO-94/12761 discloses a process for kinetically inhibiting gas hydrate formation by the use of polyvinyllactams having a molecular weight of M_{W}>40000 D, and WO-93/25798 discloses such a process using polymers and/or copolymers of vinylpyrrolidone having a molecular weight of M_{W}>5000 to 40000 D.

EP-A-0 896 123 discloses gas hydrate inhibitors which may comprise copolymers of alkoxylated methacrylic acid without alkyl end capping and cyclic N-vinyl compounds.

U.S. Pat. No. 5,244,878 describes a process for retarding the formation or reducing the tendency to form gas hydrates. To this end, polyols which are esterified with fatty acids or alkenylsuccinic anhydrides are used. The compounds prepared do not have any amino acid functions which can interact with clathrates (cage molecules).

Biodegradable pyroglutamic esters are described in DE-10 2005 054 037, where the inventive compounds are prepared by reacting polyols with pyroglutamic acid or glutamic acid.

WO-1990/13544 describes polymerizable pyrrolidonyl 4,5-unsubstituted oxazole monomers and homo- and copolymers thereof, which have excellent hydrotropic properties. Use of these polymers as gas hydrate inhibitors is not disclosed.

The additives described have only limited efficacy as kinetic gas hydrate inhibitors and/or antiagglomerants, have to be used with coadditives, or are unobtainable in a sufficient amount or obtainable only at high cost.

In order to be able to use gas hydrate inhibitors even in the case of greater subcooling than currently possible, i.e. further within the hydrate region, a further enhancement of action is required in comparison to the prior art hydrate inhibitors. In addition, improved products are desired with regard to their biodegradability.

It was thus an object of the present invention to find additives which both slow the formation of gas hydrates (kinetic inhibitors) and keep gas hydrate agglomerates small and pumpable (antiagglomerants), in order thus to ensure a broad spectrum of application with high potential action. Furthermore, they should be capable of replacing the currently used thermodynamic inhibitors (methanol and glycols), which cause considerable safety problems and logistical problems.

Since currently used inhibitors such as polyvinylpyrrolidone and polyvinylcaprolactam have only a moderate biodegradability, the inventive compounds should additionally have an improved biodegradability.

As has now been found, surprisingly, substituted polyethyleneimines are suitable as gas hydrate inhibitors. According to the structure, these polymers can delay both the nucleation and the growth of gas hydrates (kinetic gas hydrate inhibitors) and suppress the agglomeration of gas hydrates (antiagglomerants). In addition, the inventive compounds have a significantly improved biodegradability.

The invention therefore provides for the use of substituted polyethyleneimines containing structural units of the formula (1),

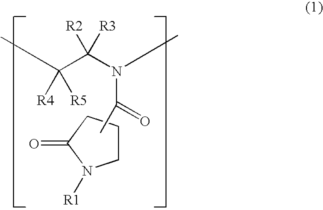

where
R1 is H, C₁-C₃₀-alkyl, C₁-C₃₀-alkenyl or C₇-C₃₀-alkylaryl
R2, R3, R4, R5 are each independently H or C₁-C₆-alkyl,
in amounts of from 0.01 to 2% by weight to prevent the formation of gas hydrates in aqueous phases which are in contact with a gaseous, liquid or solid organic phase.

The inventive substituted polyethyleneimines are, as described in WO1990/13544, preparable by cationic homo- or copolymerization of substituted oxazoles of the formula (2).

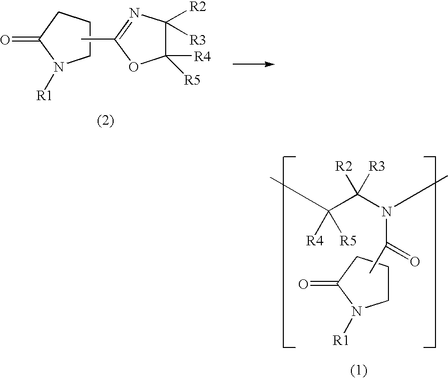

The molecular weight (M_{w}) of the inventive substituted polyethyleneimines is between 500 and 100000 g/mol, more preferably between 1000 and 20000 g/mol, especially between 2000 and 10000 g/mol.

The inventive substituted polyethyleneimines can also be prepared by copolymerizing differently substituted oxazoles, in which case the proviso applies that at least 20 mol % of the structural element of the formula (1) is present in the substituted polyethyleneimine.

Suitable compounds for copolymerization with the compounds of the formula 2 are preferably oxazoles of the formula 3

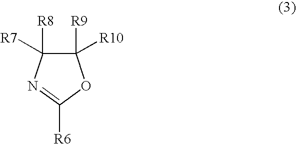

in which
R6 is H, C₁ to C₃₀-alkyl, C₂- to C₃₀-alkenyl, C₆-C₃₀-aryl or C₇ to C₃₀-alkylaryl
R7, R8, R9, R10 are each independently H or C₁- to C₆-alkyl.

Through copolymerization with the compounds of the formula 2, the compounds of the formula 3 give rise to structural units of the formula 4 in the copolymer

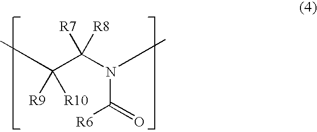

In the copolymer, preferably from 20 to 99, in particular from 40 to 95, and especially from 60 to 90 mol % of structural units of the formula 1 and from 1 to 80, in particular from 5 to 60 and especially from 10 to 40 mol % of structural units of the formula 4 are present.

Shown here by way of example is the copolymerization of 4-(4,5-dihydrooxazol-2-yl)isobutylpyrrolidin-2-one (formula (5)) with 2-ethyl-4,5-dihydrooxazole (formula (6)):

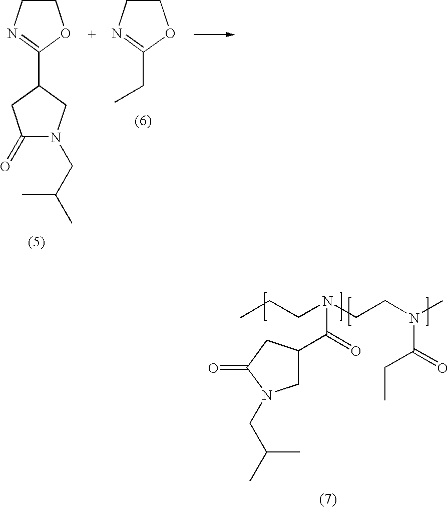

The substituted oxazoles used for the preparation of the inventive substituted polyethyleneimines can be prepared by prior art processes according to methods A and B:
A Reaction of pyroglutamic acid (formula (8) where R1=H) with a 2-aminoethanol of the formula (9)

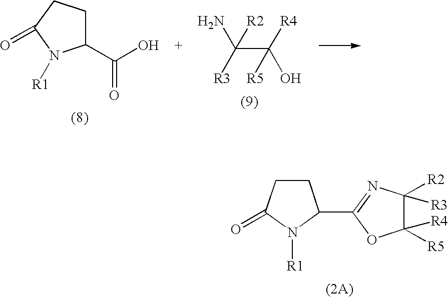

B Reaction of N-alkyl-5-oxopyrrolidine-3-carboxylic acid of the formula (10) with a 2-aminoethanol of the formula (9)

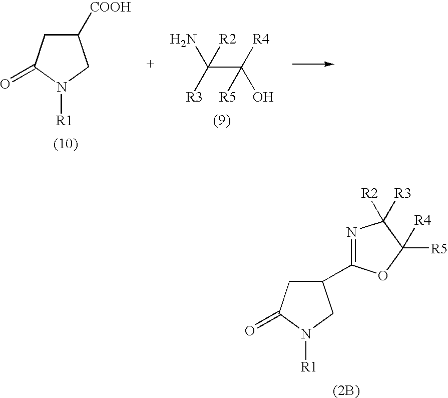

where R2, R3, R4, R5 are each hydrogen or an aliphatic organic radical having from 1 to 6, and preferably from 1 to 2 carbon atoms. Particularly preferred alcohols of the formula (11) are aminoethanol, 2-amino-1-propanol, 2-amino-1-butanol and 2-amino-2-methyl-1-propanol.

The invention further provides a process for inhibiting the formation of gas hydrates by adding substituted polyethyleneimines in amounts of from 0.01 to 2% by weight to an aqueous phase which is in contact with a gaseous, liquid or solid organic phase and in which gas hydrate formation is to be prevented.

The inventive oxazoles are prepared by uncatalyzed or transition metal catalyzed condensation of pyroglutamic acid (formula (8) where R1=H) or N-alkyl-5-oxopyrrolidine-3-carboxylic acid of the formula (10) with the amino alcohol of the formula (11). The reaction temperature is generally between 100 and 300° C., preferably from 140 to 220° C.

The reaction can be carried out under atmospheric pressure or reduced pressure. Homogeneous catalysts for the ring closure reaction include tetravalent titanium and zirconium catalysts which are used in amounts of from 0.1 to 5% by weight, based on the weight of the reaction mixture (M. Beck et al., Die Angewandte Makromolekulare Chemie 223 (1994), 217-233). The esterification takes generally from 3 to 30 hours.

The molar ratio of amino alcohol to the carboxylic acid employed in the oxazole synthesis is preferably between 1:1 and 2:1, especially between 1.25:1 and 1.5:1.

The substituted oxazoles of the formula (2) are polymerized by using a cationic initiator to the inventive substituted polyethyleneimines. The cationic polymerization can be initiated by an alkyl halide, a boron-fluorine compound, an antimony-fluorine compound, a strong acid or an ester thereof. Typical polymerization initiators are dimethyl sulfate and methyl p-toluenesulfonate. The polymerization is effected in solution or in bulk at a temperature between 70 and 170° C.

The inventive substituted polyethyleneimines can be used alone or in combination with other known gas hydrate inhibitors. In general, an amount of the inventive substituted polyethyleneimine sufficient to obtain sufficient inhibition under the given pressures and temperature conditions, will be added to the system which tends to form hydrates. The inventive substituted polyethyleneimines are generally used preferably in amounts between 0.02 and 1% by weight (based on the weight of the aqueous phase). When the inventive substituted polyethyleneimines are used in a mixture with other gas hydrate inhibitors, the concentration of the mixture is from 0.01 to 2 or from 0.02 to 1% by weight in the aqueous phase.

The substituted polyethyleneimines are preferably dissolved for use as gas hydrate inhibitors in water or in water-miscible (preferably alcoholic) solvents, for example methanol, ethanol, propanol, butanol, ethylene glycol, 1,2-propylene glycol, 1,3-propylene glycol, glycerol, diethylene glycol, triethylene glycol, N-methylpyrrolidone and oxyethylated monoalcohols, such as butylglycol, isobutylglycol, butyldiglycol.

Oil-soluble substituted polyethyleneimines are preferably dissolved for use as gas hydrate inhibitors in relatively nonpolar solvents such as C₃-C₈-ketones, for example diisobutylketone, methylisobutylketone, cyclohexanone or C₅-C₁₂-alcohols, for example 2-ethylhexanol.

### EXAMPLES OF MONOMER SYNTHESIS

### General Method of Preparing the 5-(4,5-dihydrooxazol-2-yl)pyrrolidin-2-ones

In a 500 ml four-neck flask with stirrer, thermometer, nitrogen purge and reflux condenser, 1 mol of pyroglutamic acid, 1.25 mol of aminoethanol and 0.01 mol of titanium tetraorthobutoxide were mixed and heated at 140° C. under reflux for 8 h. After cooling and replacing the reflux condenser with a distillation system, approx. 30 ml of water were distilled off at 140° C. within 6 h. Subsequently, excess aminoethanol was removed under reduced pressure at a temperature of 180° C. This affords 1 mol of 5-(4,5-dihydrooxazol-2-yl)-pyrrolidin-2-one. To check the conversion after the end of the reaction, the acid number is determined (target <5 mg KOH/g).

### Example 1

### Preparation of 5-(4,5-dihydrooxazol-2-yl)pyrrolidin-2-one

According to the general method 129 g of pyroglutamic acid were reacted with 76.3 g of aminoethanol and 3.5 g of catalyst, and 154 g of 5-(4,5-dihydrooxazol-2-yl)pyrrolidin-2-one.

### Example 2

### Preparation of 5-(4-methyl-4,5-dihydrooxazol-2-yl)pyrrolidin-2-one

According to the general method 129 g of pyroglutamic acid were reacted with 93.8 g of 2-amino-1-propanol and 3.5 g of catalyst, and 168 g of 5-(4-methyl-4,5-dihydrooxazol-2-yl)pyrrolidin-2-one were obtained.

### Example 3

### Preparation of 5-(4-ethyl-4,5-dihydrooxazol-2-yl)pyrrolidin-2-one

According to the general method 129 g of pyroglutamic acid were reacted with 111.4 g of 2-amino-1-butanol and 3.5 g of catalyst, and 177 g of 5-(4-ethyl-4,5-dihydrooxazol-2-yl)pyrrolidin-2-one were obtained.

### Example 4

### Preparation of 5-(4,4-dimethyl-4,5-dihydrooxazol-2-yl)pyrrolidin-2-one

According to the general method 129 g of pyroglutamic acid were reacted with 111.3 g of 2-amino-2-methyl-1-propanol and 3.5 g of catalyst, and 179 g of 5-(4,4-dimethyl-4,5-dihydrooxazol-2-yl)pyrrolidin-2-one were obtained.

General method for preparing the 4-(4,5-dihydrooxazol-2-yl)-1-alkylpyrrolidin-2-ones

In a 500 ml four-neck flask with stirrer, thermometer, nitrogen purge and distillation system, 1 mol of itaconic acid, 1 mol of primary amine and 0.01 mol of titanium tetraorthobutoxide mixed and the water of reaction was distilled off at 120° C. within 8 h. 1.25 mol of aminoethanol were added and the majority of the water of reaction was removed within 4 hours, then excess aminoethanol and the residues of the water of reaction were removed under reduced pressure at a temperature of 180° C. within 4 h. This affords 1 mol of 4-(4,5-dihydrooxazol-2-yl)-1-alkylpyrrolidin-2-one.

### Example 5

### Preparation of 4-(4,5-dihydrooxazol-2-yl)-1-methylpyrrolidin-2-one

The general method was employed and 130 g of itaconic acid were reacted with 160 g of methylamine (40% in water) and 3.5 g of catalyst, and water of reaction was distilled off. Subsequently, 76.3 g of monoethanolamine were added and 156 g of 4-(4,5-dihydrooxazol-2-yl)-1-methylpyrrolidin-2-one were obtained.

### Example 6

### Preparation of 4-(4,5-dihydrooxazol-2-yl)-1-ethylpyrrolidin-2-one

The general method was employed and 130 g of itaconic acid were reacted with 64.4 g of ethylamine (70% in water) and 3.5 g of catalyst, and water of reaction was distilled off. Subsequently, 76.3 g of monoethanolamine were added and 170 g of 4-(4,5-dihydrooxazol-2-yl)-1-ethylpyrrolidin-2-one were obtained.

### Example 7

### Preparation of 4-(4,5-dihydrooxazol-2-yl)-1-propylpyrrolidin-2-one

The general method was employed and 130 g of itaconic acid were reacted with 59.1 g of propylamine and 3.5 g of catalyst, and water of reaction was distilled off. Subsequently, 76.3 g of monoethanolamine were added and 184 g of 4-(4,5-dihydrooxazol-2-yl)-1-propylpyrrolidin-2-one were obtained.

### Example 8

### Preparation of 4-(4,5-dihydrooxazol-2-yl)-1-butylpyrrolidin-2-one

The general method was employed and 130 g of itaconic acid were reacted with 73.2 g of butylamine and 3.5 g of catalyst, and water of reaction was distilled off. Subsequently, 76.3 g of monoethanolamine were added and 198 g of 4-(4,5-dihydrooxazol-2-yl)-1-butylpyrrolidin-2-one were obtained.

### Example 9

### Preparation of 4-(4,5-dihydrooxazol-2-yl)-1-sec-butylpyrrolidin-2-one

The general method was employed and 130 g of itaconic acid were reacted with 73.2 g of 2-aminobutane and 3.5 g of catalyst, and water of reaction was distilled off. Subsequently, 76.3 g of monoethanolamine were added and 198 g of 4-(4,5-dihydrooxazol-2-yl)-1-sec-butylpyrrolidin-2-one were obtained.

### Example 10

### Preparation of 4-(4-ethyl-4,5-dihydrooxazol-2-yl)isobutylpyrrolidin-2-one

The general method was employed and 130 g of itaconic acid were reacted with 73.2 g of isobutylamine and 3.5 g of catalyst, and water of reaction was distilled off. Subsequently, 111.3 g of 2-amino-1-butanol were added and 225 g of 4-(4-ethyl-4,5-dihydrooxazol-2-yl)isobutylpyrrolidin-2-one were obtained.

### Example 11

### Preparation of 4-(4,5-dihydrooxazol-2-yl)-1-octadec-9-enyl-pyrrolidin-2-one

The general method was employed and 130 g of itaconic acid were reacted with 267.3 g of octadec-9-enylamine and 3.5 g of catalyst, and water of reaction was distilled off. Subsequently, 76.3 g of monoethanolamine were added and 406 g of 4-(4,5-dihydrooxazol-2-yl)-1-octadec-9-enyl-pyrrolidin-2-one were obtained.

### Example 12

### Preparation of 4-(4-ethyl-4,5-dihydrooxazol-2-yl)-1-octadec-9-enyl-pyrrolidin-2-one

The general method was employed and 130 g of itaconic acid were reacted with 267.3 g of octadec-9-enylamine and 3.5 g of catalyst, and water of reaction was distilled off. Subsequently, 111.3 g of 2-amino-1-butanol were added and 434 g of 4-(4-ethyl-4,5-dihydrooxazol-2-yl)-1-octadec-9-enyl-pyrrolidin-2-one were obtained.

### Example 13

### Preparation of 4-(4,5-dihydrooxazol-2-yl)-1-octylpyrrolidin-2-one

The general method was employed and 130 g of itaconic acid were reacted with 129.2 g of octylamine and 3.5 g of catalyst, and water of reaction was distilled off. Subsequently, 76.3 g of monoethanolamine were added and 297 g of 4-(4,5-dihydrooxazol-2-yl)-1-octylpyrrolidin-2-one were obtained.

General method for preparing the substituted polyethyleneimines

A 500 ml four-neck flask with stirrer, thermometer, nitrogen purge and reflux condenser was initially charged with 200 g of oxazole and 400 g of N-methylpyrrolidone and 0.01 mol % of methyl p-toluenesulfonate was added. The reaction mixture is stirred at 100° C. for 20 h and at 130° C. for 8 h.

### Example 14

5-(4,5-dihydrooxazol-2-yl)pyrrolidin-2-one was polymerized by the general method. No oxazole could be detected any longer by means of IR spectroscopy; the molar mass of the polymer was M_{w}=5500 g/mol.

### Example 15

5-(4-methyl-4,5-dihydrooxazol-2-yl)pyrrolidin-2-one was polymerized by the general method. No oxazole could be detected any longer by means of IR spectroscopy; the molar mass of the polymer was M_{w}=3400 g/mol.

### Example 16

5-(4-ethyl-4,5-dihydrooxazol-2-yl)pyrrolidin-2-one was polymerized by the general method. No oxazole could be detected any longer by means of IR spectroscopy; the molar mass of the polymer was M=2700 g/mol.

### Example 17

5-(4,4-dimethyl-4,5-dihydrooxazol-2-yl)pyrrolidin-2-one was polymerized by the general method. No oxazole could be detected any longer by means of IR spectroscopy; the molar mass of the polymer was M_{w}=3100 g/mol.

### Example 18

4-(4,5-dihydrooxazol-2-yl)-1-methylpyrrolidin-2-one was polymerized by the general method. No oxazole could be detected any longer by means of IR spectroscopy; the molar mass of the polymer was M_{w}=5900 g/mol.

### Example 19

4-(4,5-dihydrooxazol-2-yl)-1-ethylpyrrolidin-2-one was polymerized by the general method. No oxazole could be detected any longer by means of IR spectroscopy; the molar mass of the polymer was M_{w}=5500 g/mol.

### Example 20

4-(4,5-dihydrooxazol-2-yl)-1-propylpyrrolidin-2-one was polymerized by the general method. No oxazole could be detected any longer by means of IR spectroscopy; the molar mass of the polymer was M_{w}=5300 g/mol.

### Example 21

4-(4,5-dihydrooxazol-2-yl)-1-butylpyrrolidin-2-one was polymerized by the general method. No oxazole could be detected any longer by means of IR spectroscopy; the molar mass of the polymer was M_{w}=4800 g/mol.

### Example 22

4-(4,5-dihydrooxazol-2-yl)-1-sec-butylpyrrolidin-2-one was polymerized by the general method. No oxazole could be detected any longer by means of IR spectroscopy; the molar mass of the polymer was M_{w}=5100 g/mol.

### Example 23

4-(4,5-dihydrooxazol-2-yl)isobutylpyrrolidin-2-one was polymerized by the general method. No oxazole could be detected any longer by means of IR spectroscopy; the molar mass of the polymer was M_{w}=6200 g/mol.

### Example 24

4-(4,5-dihydrooxazol-2-yl)-1-octadec-9-enylpyrrolidin-2-one was polymerized by the general method. No oxazole could be detected any longer by means of IR spectroscopy; the molar mass of the polymer was M_{w}=5800 g/mol.

### Example 25

4-(4-ethyl-4,5-dihydrooxazol-2-yl)-1-octadec-9-enylpyrrolidin-2-one was polymerized by the general method. No oxazole could be detected any longer by means of IR spectroscopy; the molar mass of the polymer was M_{w}=2900 g/mol.

### Example 26

A 1:1 molar mixture of 4-(4,5-dihydrooxazol-2-yl)-1-methylpyrrolidin-2-one and 4-(4,5-dihydrooxazol-2-yl)isobutylpyrrolidin-2-one was polymerized by the general method. No oxazole could be detected any longer by means of IR spectroscopy; the molar mass of the polymer was M_{w}=5300 g/mol.

### Example 27

4-(4,5-dihydrooxazol-2-yl)-1-octylpyrrolidin-2-one was polymerized by the general method. No oxazole could be detected any longer by means of IR spectroscopy; the molar mass of the polymer was M_{w}=4200 g/mol.

Efficacy of the substituted polyethyleneimines as gas hydrate inhibitors

To study the inhibiting action of the substituted polyethyleneimines, a stirred steel autoclave with temperature control, pressure and torque sensor of capacity 450 ml was used. For studies of kinetic inhibition, the autoclave was filled with distilled water and gas in a volume ratio of 20:80; for studies of agglomerate inhibition, condensate was additionally added. Subsequently, 50 bar of natural gas were injected.

Proceeding from a starting temperature of 20° C., the autoclave was cooled to 4° C. within 3 h, then stirred at 4° C. for 18 h and heated back to 20° C. within 2 h. At first, a pressure decrease corresponding to the thermal compression of the gas is observed. When the formation of gas hydrate nuclei occurs during the cooling time, the pressure measured falls, and a rise in the torque measured and a slight increase in the temperature are observed. Without inhibitor, further growth and increasing agglomeration of the hydrate nuclei lead rapidly to a further rise in the torque. When the mixture is heated, the gas hydrates decompose, so that the starting state of the experimental series is attained.

The measure used for the inhibiting action of the polymer is the time from the attainment of the minimum temperature of 4° C. until the first gas absorption (T_{ind}) or the time until the torque rises (T_{agg}). Long induction times or agglomeration times indicate an effect as a kinetic inhibitor. The torque measured in the autoclave serves, in contrast, as a parameter for the agglomeration of the hydrate crystals. In the case of a good antiagglomerant, the torque which builds up after gas hydrates have formed is significantly reduced compared to the blank value. In the ideal case, snowlike, fine hydrate crystals form in the condensate phase, do not agglomerate and thus do not lead to blockage of the installations serving for gas transport and for gas extraction.

Test Results

Composition of the natural gas used:

methane 84.8%, ethane 9.2%, propane 2.6%, butane 0.9%, carbon dioxide 1.6%, nitrogen 0.9%.

The comparative substance used was a commercially available gas hydrate inhibitor based on polyvinylpyrrolidone. The dosage in all tests was 5000 ppm based on the water phase.

| Substituted polyethyleneimines | | |
|---|---|---|
| from example | T_{ind} (h) | T_{agg} (h) |
| Blank value | 0 | 0 |
| 14 | 15.0 | 15.5 |
| 15 | 15.6 | 15.8 |
| 16 | 17.1 | 17.2 |
| 17 | 18.0 | 18.4 |
| 18 | 17.9 | 18.3 |
| 19 | 19.5 | 19.9 |
| 20 | 20.7 | 21.4 |
| 21 | 22.5 | 23.2 |
| 22 | 24.1 | 24.7 |
| 23 | 25.0 | 25.8 |
| 26 | 21.5 | 22.0 |
| Comparative | 3.5 | 3.6 |

As can be seen from the above test results, the inventive substituted polyethyleneimines act as kinetic gas hydrate inhibitors and show a clear improvement over the prior art.

In order to test the action as agglomerate inhibitors, the test autoclave used above was initially charged with water and white spirit (20% of the volume in a ratio of 1:2) and, based on the water phase, 5000 ppm of the particular additive were added.

At an autoclave pressure of 50 bar and a stirrer speed of 500 rpm, the temperature of initially 20° C. was cooled to 4° C. within 3 hours, then the autoclave was stirred at 4° C. for 18 hours and heated up again. In the course of this, the agglomeration time until the occurrence of gas hydrate agglomerates and the torque which occurred at the stirrer at that time were measured, the latter being a measure for the agglomeration of the gas hydrates.

The comparative substance employed was a commercially available antiagglomerant (quaternary ammonium salt).

| Substituted polyethyleneimines | | |
|---|---|---|
| from example | T_{agg} (h) | Mₘₐₓ (Ncm) |
| Blank value | 0.1 | 15.9 |
| 25 | 3.1 | 1.2 |
| 27 | 3.5 | 1.1 |
| Comparative | 2.6 | 4.1 |

As can be seen from these examples, the torques measured are greatly reduced compared to the blank value in spite of gas hydrate formation. This suggests a significant agglomerate-inhibiting action of the inventive products. In addition, the products also have significant action as kinetic inhibitors under test conditions. All examples show a significantly better performance than the commercially available antiagglomerant (comparative=state of the art).

The significantly better biodegradability (to OECD 306) of some selected inventive compounds compared to the state of the art (commercially available polyvinylpyrrolidone) is shown below.

| Substituted polyethyleneimines from | Biodegradability |
|---|---|
| example | 28 days (OECD 306) |
| Polyvinylpyrrolidone | 5 |
| 14 | 72 |
| 19 | 68 |
| 20 | 65 |
| 21 | 65 |
| 22 | 55 |
| 23 | 63 |
| 24 | 30 |
| 26 | 70 |
| 27 | 42 |

1. A process for the prevention of the formulation of gas hydrates in an aqueous phase, wherein the aqueous phase is in contact with a gaseous, liquid or solid organic phase comprising the step of contacting the gaseous, liquid or solid organic phase with at least one substituted polyethyleneimine containing repeat structural units of the formula (1), 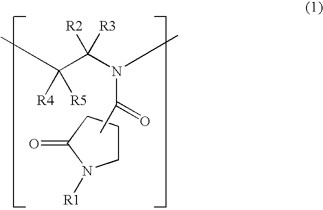
wherein
R1 is H, C₁-C₃₀-alkyl, C₁-C₃₀-alkenyl or C₇-C₃₀-alkylaryl
R2, R3, R4, R5 are each independently H or C₁-C₆-alkyl,
in amounts of from 0.01 to 2% by weight.

2. The process as claimed in claim 1, wherein the least one substituted polyethyleneimine is a homopolymer containing repeat structural units of the formula 1.

3. The process as claimed in claim 1, wherein the molecular weight (M_{w}) of the at least one substituted polyethyleneimine is between 500 and 100000 g/mol.

4. The process as claimed in claim 1, wherein the at least one substituted polyethyleneimine is a copolymer containing at least 20 mol % of repeat structural units of the formula (1).

5. The process as claimed in claim 1, wherein the at least one substituted polyethyleneimine is a copolymer which, as well as structural units of the formula 1, comprises those of the formula 4 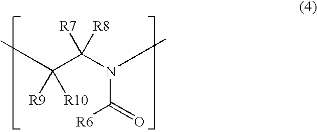
wherein
R6 is H, C₁- to C₃₀-alkyl, C₂- to C₃₀-alkenyl, C₆-C₃₀-aryl or C₇ to C₃₀-alkylaryl
R7, R8, R9, R10 are each independently H or C₁- to C₆-alkyl.

6. The process as claimed in claim 5, wherein R6 is an ethyl group and R7, R8, R9, R10 are each hydrogen.

7. The process as claimed in claim 1, wherein the at least one substituted polyethyleneimine contains from 20 to 99 mol % of structural units of the formula 1.

8. The process as claimed in claim 1, wherein the at least one substituted polyethyleneimine contains from 1 to 80 mol % of structural units of the formula 4.

9. A compound for the prevention of the formulation of gas hydrates in an aqueous phase comprising at least one substituted polyethyleneimine containing repeat structural units of the formula (1), 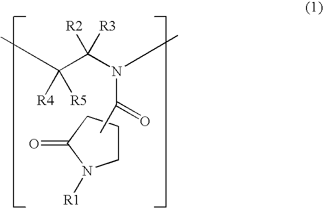
wherein
R1 is H, C₁-C₃₀-alkyl, C₁-C₃₀-alkenyl or C₇-C₃₀-alkylaryl; and
R2, R3, R4, R5 are each independently H or C₁-C₆-alkyl.
